(19) United States
(12) Patent Application Publication
(10) Pub. No.: US 2007/0074028 A1
(43) Pub. Date: Mar. 29, 2007

(54) Image forming apparatus

(75) Inventors: Shinji Makishima, Tokyo (JP); Kazuhiro Ogura, Fujisawa-shi (JP); Akihiro Mizutani, Tokyo (JP); Toshihiro Ida, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/236,717

(22) Filed: Sep. 28, 2005

(51) Int. Cl. H04L 9/00

(52) U.S. Cl. 713/176

(57) ABSTRACT

An image forming apparatus stores user signature data signed by using a user's second private key, signature object data, public-key certificate data and log data, and creates and stores log signature data by giving a signature to the total of these data by using a first private key. The apparatus calculates hash values for all stored log signature data, adds up the hash values and signs the total hash value by using the first private key, and stores the signed data.

### BACKGROUND OF THE INVENTION

1. Field of the Invention

The present invention relates to an image forming apparatus capable of recording a log safely.

2. Description of the Related Art

There is a known technique to enable confirmation of transmission/reception, protection of falsification and prevention of user denial by creating a communication log with a digital signature each time users make communication (Jpn. Pat. Applin. KOKAI Publication No. 2001-222219). Concretely, a digital signature value of a destination party and a hash of previous log data are recorded as a one-time log. This recording prevents log falsification and denying of communication by a remote user.

However, this method cannot detect falsification of all log data if it occurs.

Therefore, there is a need for an image forming apparatus capable of recording a log safely and preventing falsification of log data.

### BRIEF SUMMARY OF THE INVENTION

According to an aspect of the present invention, there is provided an image forming apparatus comprising a log data storing unit configured to store by associating user signature data created by giving a digital signature to a certain data by using a first private key possessed by a user, signature object data to be given the digital signature, public-key certificate data including information about a public key corresponding to the first private key, and log data indicating that an operation is performed; a first data creating unit configured to create log signature data by giving a digital signature to a total of the user signature data, signature object data, public-key certificate data, and log data stored in the log data storing unit by using the second private key, when the user signature data, signature object data, public-key certificate data and log data are stored in the log data storing unit; a log signature data storing unit configured to store the log signature data by associating with the user signature data, signature object data, public-key certificate data and log data, when the log signature data is created by the first data creating unit; a hash value calculating unit configured to calculate hash values of all log signature data stored in the log signature data storing unit, when the log signature data is stored in the log signature data storing unit; a hash value totaling unit configured to total the hash values calculated by the hash value calculating unit; a second data creating unit configured to create signature data of total log data by giving a digital signature to the hash value totaled by the hash value totaling unit by using the second private key stored in the storing unit; and a total signature data storing unit configured to store total signature data indicating the signature data of the total log data created by the second data creating unit.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a view showing schematically a network configuration in a first embodiment of the present invention;

FIG. 2 is a block diagram showing the configuration of essential components of an image forming apparatus in the same embodiment;

FIG. 3 is a flowchart showing a process of sending a print job from a PC in the same embodiment;

FIG. 4 is a flowchart showing a processing executed by the image forming apparatus in the same embodiment, when receiving a print job from the PC;

FIG. 5 is an example of management table in the same embodiment;

FIG. 6 shows an example of area to store total signature data in the same embodiment;

FIG. 7 shows an example of a management table in the same embodiment;

FIG. 8 shows an example of an area to store total signature data in the same embodiment;

FIG. 9 shows another example of a management table in the same embodiment;

FIG. 10 is a flowchart showing a processing performed by an image forming apparatus according to a second embodiment of the present invention;

FIG. 11 is a view showing schematically a network configuration in a third embodiment of the present invention; and

FIG. 12 is a flowchart showing a processing performed by an image forming apparatus in the same embodiment.

### DETAILED DESCRIPTION OF THE INVENTION

Embodiments of the present invention will be explained hereinafter with reference to the accompanying drawings.

### First Embodiment

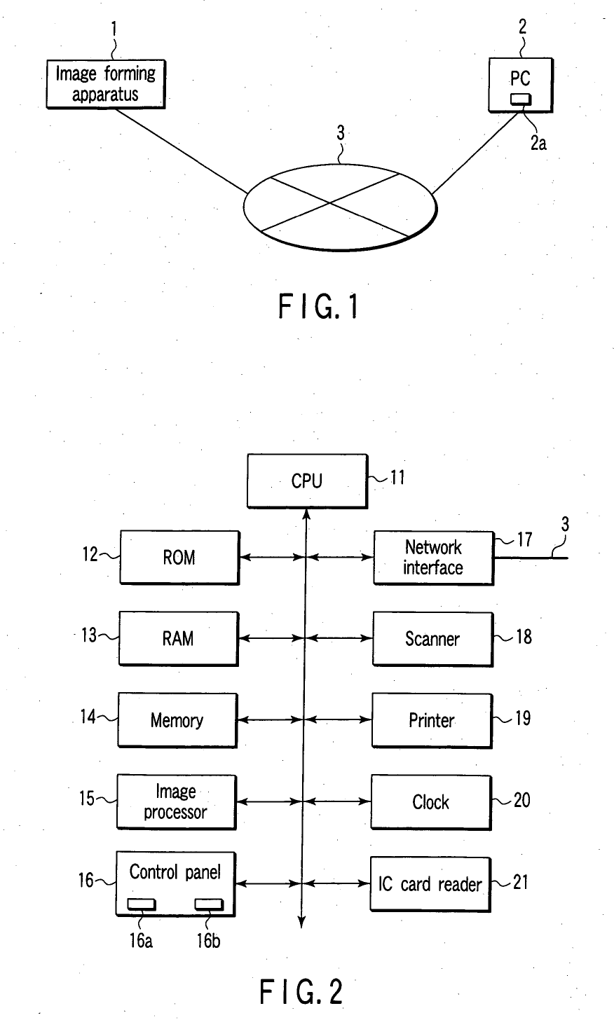

FIG. 1 shows schematically the network configuration in a first embodiment. As shown in FIG. 1, an image forming apparatus 1 and a personal computer (PC) 2 are connected to a network 3. The network 3 is an intranet or internet, for example. The image forming apparatus 1 and PC 2 can perform data transmission and reception through the network 3. The image forming apparatus 1 is a multifunction peripheral unit having the functions of printer, scanner, copier and network.

FIG. 2 is a block diagram showing the configuration of essential components of the image forming apparatus 1. As shown in FIG. 2, the image forming apparatus 1 comprises a CPU 11, a ROM 12, a RAM 13, a memory 14, an image processor 15, a control panel 16, a network interface 17, a scanner 18, a printer 19, a clock 20 and an IC card reader 21. The CPU 11, ROM 12, RAM 13, memory 14, image processor 15, control panel 16, network interface 17, scanner 18, printer 19, clock 20 and IC card reader 21, through a bus line.

The CPU 11 controls the whole image forming apparatus 1 by executing a control program stored in the ROM 12. The ROM 12 stores a fixed data and a control program executed by the CPU 11. The RAM 13 has a work area required by the CPU 11 to execute the control program stored in the ROM 12. The memory 14 is a hard disk drive, for example. The memory 14.stores various data, such as image data, a management table to manage the data about a log described later, total signature data described later, and a first secret key to give a digital signature on data. The first secret key in the memory 14 is stored safely not to be referred to by a third party. The image processor 15 performs compression and decompression of image data. The control panel 16 has a control unit 16a and a display unit 16b. The control unit 16a informs the CPU 11 of an instruction received from a user. The display unit 16b displays the information necessary for the user under the control of CPU 11. The network interface 17 is used for connection with the network 3. The scanner 18 reads an image from an original set on a not-shown original table or from an original sent from a not-shown automatic paper supply unit, and creates an image data. The created image data is compressed by the image processor 15, and stored in the memory 14. The printer 19 forms an image on a recording paper sheet based on the print data received from the PC 2 or the image data read from the memory 14 and decompressed by the image processor 15. The clock 20 creates date and time information. The date and time information created by the clock 20 is supplied to the CPU 11 at need. The IC card reader 21 reads the information stored in an IC card.

Next, the PC 2 will be explained. The PC 2 has a storage unit or a hard disk drive 2a, for example. The hard disk drive 2a stores a second secret key used by a user to give a signature to a certain data. In the first embodiment, the second secret key used by the user to give a signature to a certain data will be explained as being stored in the hard disk drive 2a. However, it is permitted to store the second secret key and public-key certificate data to indicate a public-key certificate in an IC card. The IC card is used by the user to scan an original by using the scanner 18, for example. A case of using the IC card will be explained later in second embodiment. If the PC 2 has an USB interface, it is permitted to store data indicating the second secret key and public-key certificate in a USB token device.

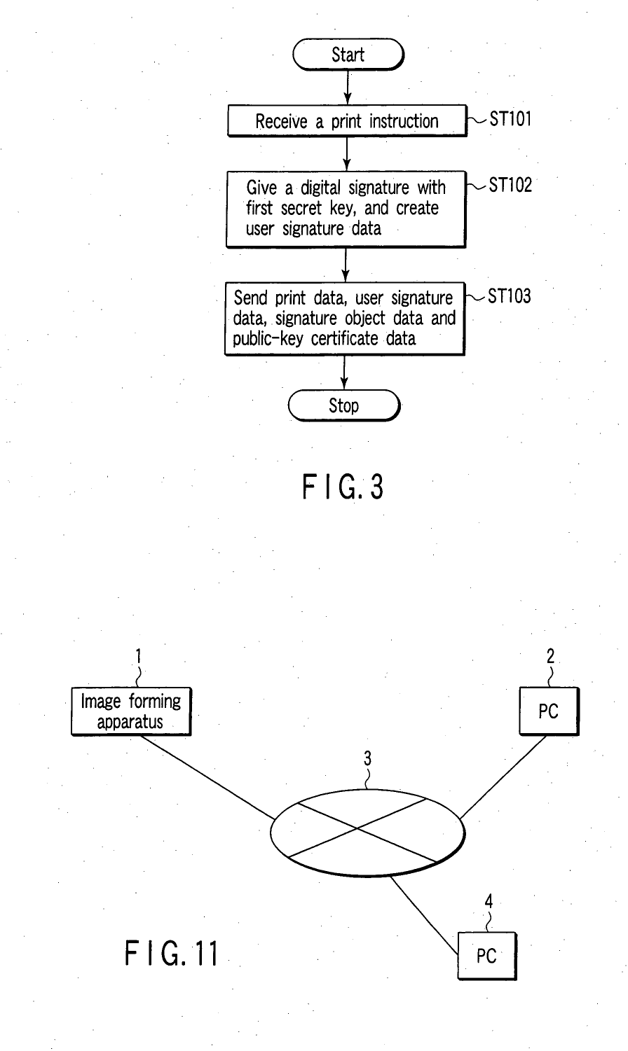

Now, explanation will be given on the processing executed when the PC 2 sends a print job to the image forming apparatus 1. FIG. 3 is a flowchart of a process of sending a print job from the PC 2.

When printing data, the user sends a print instruction by using a printer driver from the PC 2 connected to the image forming apparatus 1 through the network 3. Namely, the PC 2 receives the print instruction from the user through the printer driver (ST 101). When the PC2 receives a print instruction from the user in this way, the PC 2 gives a digital signature to the data instructed to print by using the second secret key stored in the hard disk drive 2a, and creates user signature data (ST 102). The user signature data is a random digit, print data stored as a log, or an image of print data. The PC 2 sends the image forming apparatus 1 the user signature data with the user's signature, signature object data to be given a signature, and public-key certificate data indicating a public-key certificate to verify the signature data (ST 103). In this time, the user signature data, signature object data and public-key certificate data may be sent by being included in the header of print job. The above-mentioned user signature data may include the signature object data and public-key certificate data. A public-key certificate is a digital certification issued by a third party organization. A public certification includes information such as a name to specify a user, a public key for a private key, and signature data created by a third party organization for verifying that the public key is owned by the user.

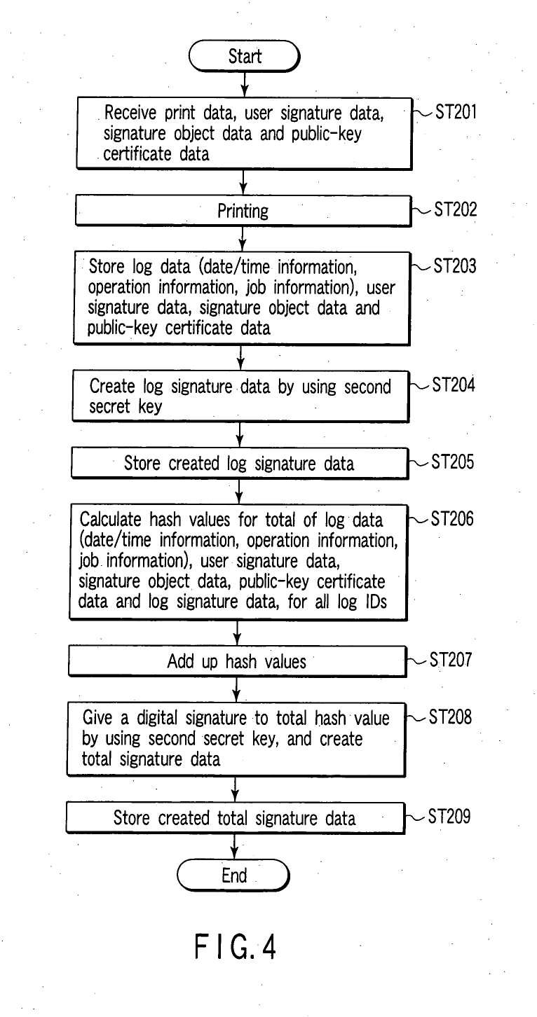

Next, explanation will be given on the processing executed by the image forming apparatus 1 when receiving user signature data, signature object data and public-key certificate data together with a print job from the PC 2 as described above. FIG. 4 is a flowchart of the processing executed by the CPU 11 when receiving a print jib.

Receiving user signature data, signature object data and public-key certificate data together with a print job (ST 201), the CPU 11 controls the printer 19 and execute printing based on the image data included in the print job (ST 202). After the printing, the CPU 11 stores the received user signature data, signature object data and public-key certificate data in the memory 14, in addition to the log data indicating that an operation is performed by the user's instruction, such as, date/time information indicating the date and time to execute the printing, operation information indicating the kinds of operation executed by the user such as printing, scanning and copying, and job information about the printing data such as a file name of printed data or the data (ST 203). Concretely, a new log ID is issued on a management table described later with reference to FIG. 6, and areas are created corresponding to the log ID to store the log data (date/time information, operation information, job information), user signature data, signature object data, public-key certificate data, log signature data. The date/time information obtained from the clock 20, operation information included in a print job (e.g., print), job information (e.g., file name), received user signature data, signature object data and public-key certificate data are stored in the areas created to store the date/time information, operation information, job information, user signature data, signature object data, and public-key certificate data.

Then, the CPU 11 gives a digital signature to the total data of the date/time information, operation information, job information, user signature data, signature object data and public-key certificate data stored in the management table, by using the first secret key saved in the memory 14, and creates log signature data (ST 204). The CPU stores the log signature data in the log signature data storing area by associating with the information and data used for creating the log signature data (ST 205). Thus, the created log signature data is managed on the management table by the same log ID as that the information and data used for creating the log signature data.

After storing the log signature data on the management table of the memory 14, the CPU 11 calculates hash values of the total data of the date/time information, operation information, job information, user signature data, signature object data, public-key certificate data and log signature data, for all log IDs on the management table (ST 206). The hash values calculated in this way are temporarily stored in a work area of the RAM 13, for example.

After calculating hash values for all log IDs, the CPU 11 totals the hash values stored temporarily in the work area of the RAM 13 (ST 207). Then, the CPU 11 gives a digital signature to the total hash value by using the first secret key stored in the memory 14, and creates total signature data (ST 208). After creating the total signature data in this way, the CPU 11 stores the created total signature data in the memory 14 (ST 209). In this time, when the total signature data has already been stored in the memory 14, the total signature data is overwritten, and the data is updated.

Next, explanation will be given on the function of the image forming apparatus 1 configured as above described when printing based on a print job sent from the PC 2, in the state that a log is not registered on the management table.

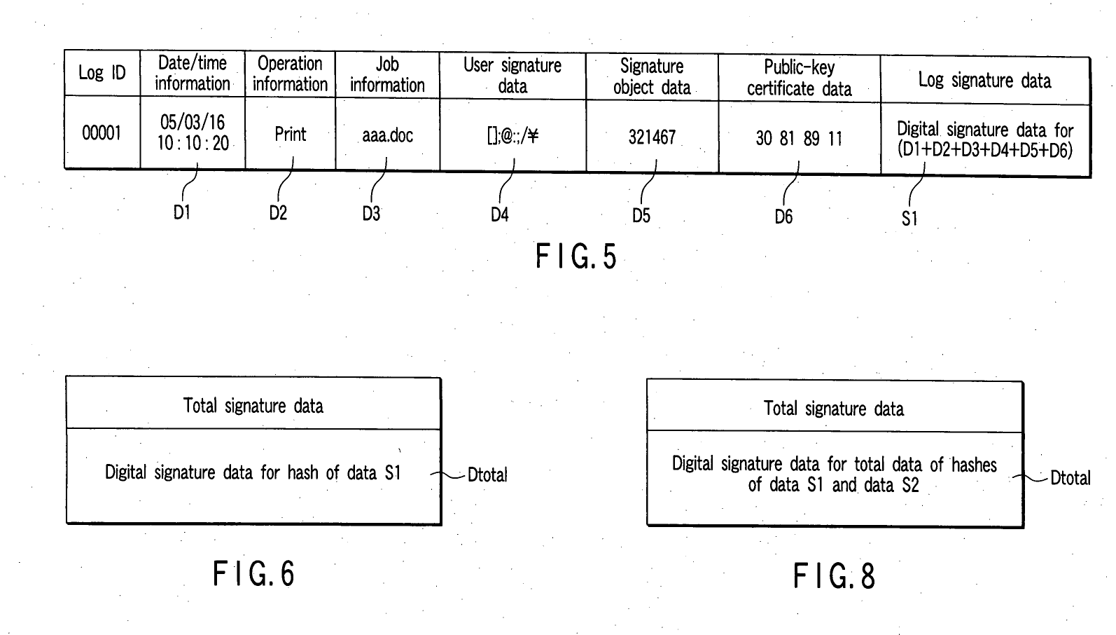

When receiving a print job from the PC 2, the image forming apparatus receives user signature data, signature object data and public-key certificate data together with the print job. After receiving these data, the image forming apparatus obtains date/time information from the clock 20, and operation information and job information from the print job. The obtained information and data are stored and managed on the management table in the memory 14. The process of storing the data on the management table will be explained hereinafter with reference to FIG. 5 and FIG. 6.

FIG. 5 shows an example of management table. The management table has areas to store log data (date/time information, operation information, job information), user signature data, signature object data, public-key certificate data and log signature data, for each log ID. When a print job mentioned above is received, data is stored in respective areas of a log ID “00001” for example on the management table as shown in FIG. 5. That is, the date/time data D1 “05/01/16 10:10:20” is stored in the date/time area, the operation information data D2 “Print” is stored in the operation information area, the job information data D3 “aaa.doc” is stored in the job information area, the user signature data D4 “[];@:;/¥” is stored in the user signature data area, the signature object data D5 “321467” is stored in the signature object data area, and the public-key certificate data D6 “30 81 89 11” is stored in the public-key certificate data area.

After the log data (date/time information, operation information, job information), user signature data, signature object data, public-key certificate data are stored in the management table, a digital signature is given to the total data (D1+D2+D3+D4+D5+D6) by using the first secret key, and the log signature data S1 is created. The created log signature data S1 is stored in association with the log ID “00001”.

Then, a hash is calculated for the total data of log data (date/time information, operation information, job information), user signature data, signature object data, public-key certificate data and log signature data corresponding to the log ID “00001”. If only the log ID “00001” is stored on the management table, a digital signature is given to a hash value calculated for the log ID “00001” by using the first secret key, and a total signature data is created. The created total signature data Dtotal is stored in the memory 14. FIG. 6 shows an example of area to store the total signature data. This area stores the data with a digital signature to a hash value of data S1, as a total signature data Dtotal.

Next, explanation will be given on the operations of the image forming apparatus 1 when the user PC 2 makes a print instruction to the image forming apparatus 1, with reference to FIG. 7 and FIG. 8. When the image forming apparatus 1 receives a print job, a new log ID “00002” is issued on the management table. Areas to store log data (date/time information, operation information, job information), user signature data, signature object data, public-key certificate data and log signature data are created for the log ID “00002”. Then, data is stored in respective areas of the log ID “00002” on the management table as shown in FIG. 7. That is, the date/time data D7 “05/03/17 12:32:40” is stored in the date/time area, the operation information data D8 “Print” is stored in the operation information area, the job information data D9 “bbb.doc” is stored in the job information area, the user signature data D10 “+:*@;* *+−” is stored in the user signature data area, the signature object data D11 “127439” is stored in the signature object data area, and the public-key certificate data D12 “11 44 53 36” is stored in the public-key certificate data area.

After the log data (date/time information, operation information, job information), user signature data, signature object data, public-key certificate data are stored in the management table, a digital signature is given to the total data (D7+D8+D9+D10+D11+D12) by using the first secret key, and the log signature data S2 is created. The created log signature data S2 is stored in association with the log ID “00002”.

Then, a hash is sequentially calculated for the total data of log data (date/time information, operation information, job information), user signature data, signature object data, public-key certificate data and log signature data, corresponding to the log IDs “00001” and “00002”. The calculated hash values are added up. A digital signature is given to the total hash value by using the first secret key, and a total signature data Dtotal is created. The created total signature data Dtotal is stored in the memory 14. The total signature data Dtotal is updated by this. FIG. 8 shows an example of area to store the total signature data. This area stores the data with a digital signature for the total hash value of data S1 and S2, as a total signature data.

According to the above first embodiment, by storing the user signature data as a user's signature value and the log signature data as a signature value for a log, the image forming apparatus 1 can prevent user's denying of operation and can prove the perfectness of the log stored in the management table.

By updating the total signature data Dtotal as signature values for all logs each time an operation is performed, the image forming apparatus 1 can prevent falsification of data and can store a log safely.

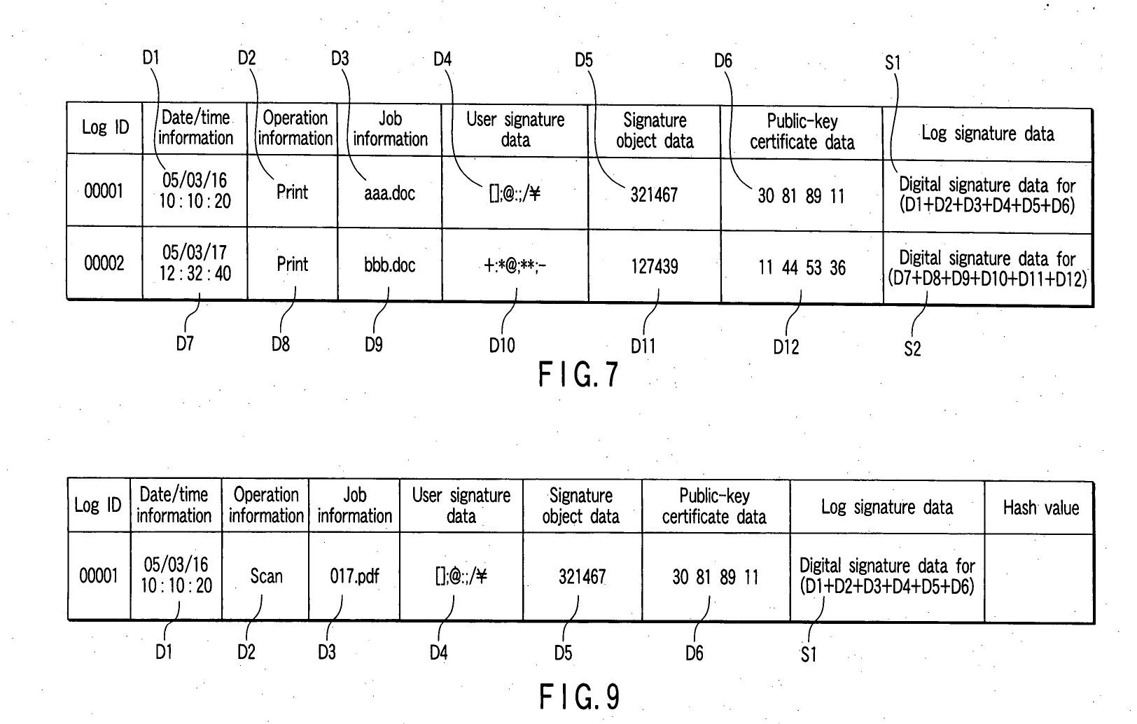

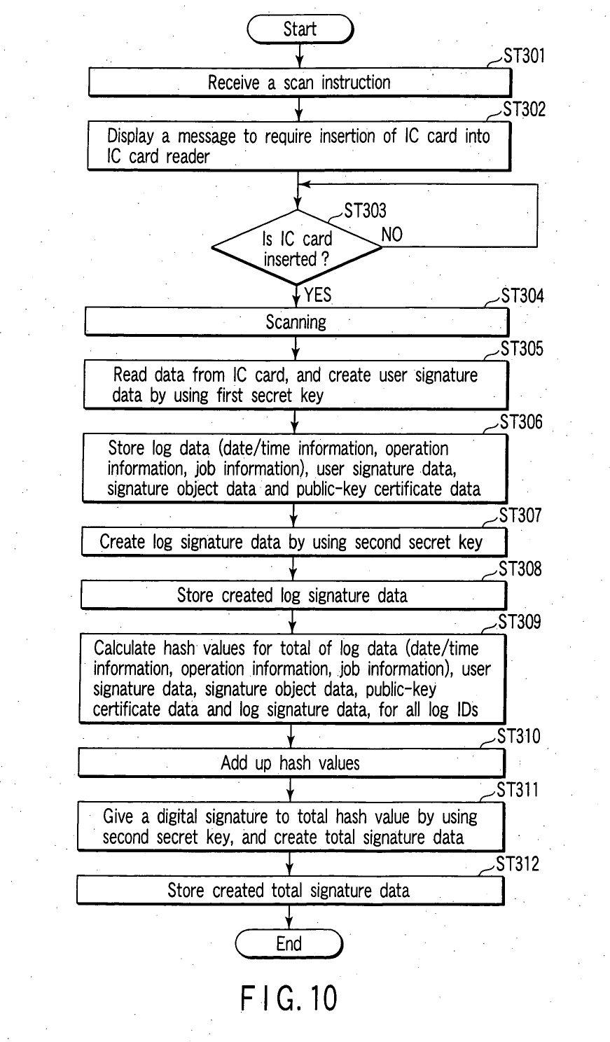

In the above-mentioned first embodiment, a hash is calculated for all logs each time a log is stored, the calculated hash values are added up, and a digital signature is given to the total hash value by using the first secret key. However, as shown in FIG. 9, it is permitted to provide an area to store a hash value on the management table for each log ID, and use a hash value stored in this area. A hash value is calculated before creating total signature data, after storing log signature data. Thus, it is permitted to store a hash value in the hash value area on the management table, without storing temporarily in the RAM 13 when it is calculated. As an area to store a hash value is provided, a hash value may be calculated in step ST 206 only for the data corresponding to a log to store this time. This configuration makes the processing easy.

### Second Embodiment

Now, a second embodiment will be explained. The same reference numerals are given to the same components as those of the first embodiment, and detailed explanation will be omitted. In the second embodiment, a second secret key and a public-key certificate possessed by the user are stored in an IC card. Explanation will be given on a case that when scanning an original, the user reads the second secret key and the public-key certificate from the IC card, and signs them. The hardware configuration of the image forming apparatus 1 is the same as the first embodiment, and explanation will be omitted.

FIG. 10 shows a flowchart of the processing executed by the CPU 11 when performing a scanning operation. Receiving a scan instruction from the operation unit 16a of the control panel 16 (ST 301), the CPU 11 displays a message to require insertion of IC card (ST 302).

The CPU 11 judges whether the IC card is inserted into the IC card reader 21 (ST 303). When the CPU 11 judges that the IC card is not inserted (NO in ST 303), the CPU 11 continues the standby state. When the CPU 11 judges that the IC card is inserted (YES in ST 303), the CPU 11 starts scanning (ST 304). When the scanning is finished, the CPU 11 reads the data indicating the second secret key and public-key certificate from the IC card, gives a digital signature to a certain data by using the second secret key, and creates user signature data (ST 305). As a certain data to be signed by the user, there are random digits, data read optically from an original by scanning, or an image of that data. By performing the above processing, the user signature data, signature object data and public-key certificate data are obtained. Date/time information is obtained from the clock 20, operation information is “Scan”, and job information is a file name created by optional digits, for example. The processes from ST 306 to ST 312 after obtaining the user signature data, signature object data, public-key certificate data and log data (date/time information, operation information, job information), are substantially the same as steps ST 203 to ST 209, and explanation will be omitted.

As described above, even if the data indicating the second secret key and public-key certificate is stored in the IC card, the same effect as the first embodiment can be obtained by reading the data by the IC card reader 21 and creating the user signature data, etc.

### Third Embodiment

Next, a third embodiment will be explained. The same reference numerals are given to the same components as those of the first embodiment, and detailed explanation will be omitted. The third embodiment encrypts the data stored on the management table of the memory 14 by using a key possessed by a manager to manage the image forming apparatus 1. The manager may not a manager of the image forming apparatus 1.

FIG. 11 shows schematically the network configuration in the third embodiment. In addition to the configuration explained in the first embodiment, a PC 4 of a manager is connected to the network 3. The memory 14 of the image forming apparatus 1 stores a manager's key to encrypt total signature data. As a manager's key mentioned here is a public key in a public-key encryption system, for example. As a manager's key, it is permitted to use a unique ID, or a common key in a common-key encryption system. The hardware configuration of the image forming apparatus 1 is the same as the first embodiment, and explanation will be omitted.

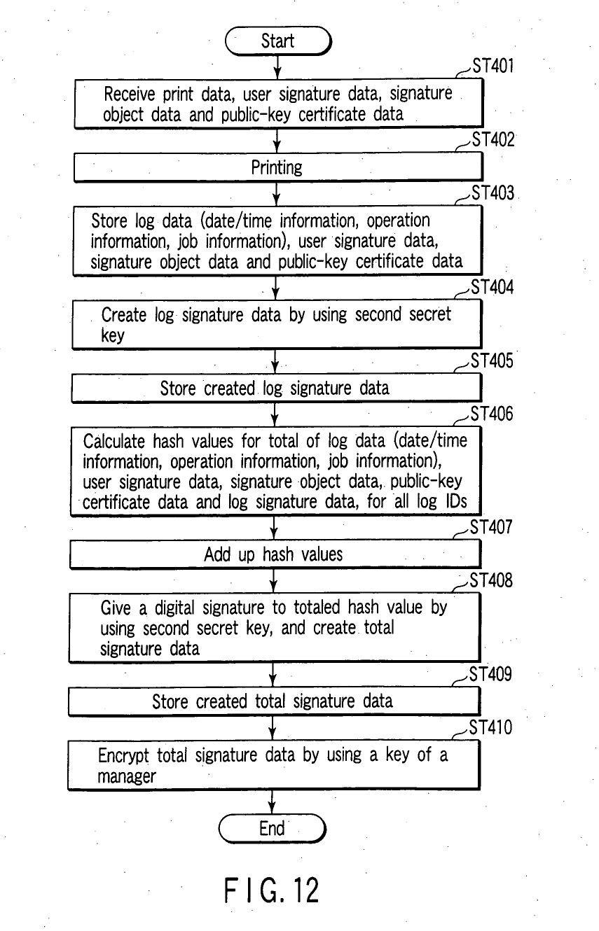

FIG. 12 is a flowchart of the processing executed by the CPU 11 when encrypting total signature data. Steps ST 401 to ST 409 are the same as steps ST 201 to ST 209 explained with reference to FIG. 4, and explanation will be omitted.

In step ST 410, the CPU 11 encrypts the data stored on the management table of the memory 14 in steps ST 401 to ST 409, by using the stored manager's key. By encrypting all data about the logs stored on the management table, persons who can refer to the contents of log can be limited only to a manager having a key for decryption.

According to the third embodiment, by encrypting the data about all logs by using a key of a specific manager, data leakage to the other persons than the manager can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus comprising:
a storing unit configured to store at least a first private key;
a log data storing unit configured to store by associating user signature data created by giving a digital signature to a certain data by using a second private key possessed by a user, signature object data to be given the digital signature, public-key certificate data including information about a public key corresponding to the second private key, and log data indicating that an operation is performed;
a first data creating unit configured to create log signature data by giving a digital signature to a total of the user signature data, signature object data, public-key certificate data, and log data stored in the log data storing unit by using the first private key, when the user signature data, signature object data, public-key certificate data and log data are stored in the log data storing unit;
a log signature data storing unit configured to store the log signature data by associating with the user signature data, signature object data, public-key certificate data and log data, when the log signature data is created by the first data creating unit;
a hash value calculating unit configured to calculate hash values of all log signature data stored in the log signature data storing unit, when the log signature data is stored in the log signature data storing unit;
a hash value totaling unit configured to total the hash values calculated by the hash value calculating unit;
a second data creating unit configured to create signature data of total log data by giving a digital signature to the hash value totaled by the hash value totaling unit by using the first private key; and
a total signature data storing unit configured to store total signature data indicating the signature data of the total log data created by the second data creating unit.

2. The image forming apparatus according to claim 1, wherein the user signature data, signature object data and public-key certificate data stored in the log data storing unit are received together with a print job through a network.

3. The image forming apparatus according to claim 1, further comprising a connecting unit configured to connect an external memory, wherein data required to create the user signature data, signature object data and public-key certificate data stored in the log data storing unit are obtained from the external memory.

4. The image forming apparatus according to claim 1, further comprising an encrypting unit configured to encrypt the user signature data, signature object data, public-key certificate data, log data, log signature data and the total signature data by using a key stored in a computer of a manager connected through a network.

5. An image forming apparatus comprising:
storing means for storing at least a first private key;
log data storing means for storing by associating user signature data created by giving a digital signature to a certain data by using a second private key possessed by a user, signature object data to be given the digital signature, public-key certificate data including information about a public key corresponding to the second private key, and log data indicating that an operation is performed;
first data creating means for creating log signature data by giving a digital signature to a total of the user signature data, signature object data, public-key certificate data, and log data stored in the log data storing means by using the first private key, when the user signature data, signature object data, public-key certificate data and log data are stored in the log data storing means;
log signature data storing means for storing the log signature data by associating with the user signature data, signature object data, public-key certificate data and log data, when log signature data is created by the first data creating means;
hash value calculating means for calculating hash values of all log signature data stored in the log signature data storing means, when the log signature data is stored in the log signature data storing means;
hash value totaling means for totaling the hash values calculated by the hash value calculating means;
second data creating means for creating signature data of total log data by giving a digital signature to the hash value totaled by the hash value totaling means by using the first private key; and
total signature data storing means for storing total signature data indicating the signature data of the total log data created by the second data creating means.

6. The image forming apparatus according to claim 5, wherein the user signature data, signature object data and public-key certificate data stored in the log data storing means are received together with a print job through a network.

7. The image forming apparatus according to claim 5, further comprising connecting means for connecting an external memory, wherein data required to create the user signature data, signature object data and public-key certificate data stored in the log data storing means are obtained from the external memory.

8. The image forming apparatus according to claim 5, further comprising encrypting means for encrypting the user signature data, signature object data, public-key certificate data, log data, log signature data and the total signature data by using a key stored in a computer of a manager connected through a network.

9. A method of storing data of an image forming apparatus having a memory to store a first private key, comprising:
storing by associating user signature data created by giving a digital signature to a certain data by using a second private key possessed by a user, signature object data to be given the digital signature, public-key certificate data including information about a public key corresponding to the second private key, and log data indicating that an operation is performed;
creating log signature data by giving a digital signature to the total of the user signature data, signature object data, public-key certificate data, and log data stored by using the first private key;
storing the created log signature data by associating with the user signature data, signature object data, public-key certificate data and log data;
calculating hash values of all log signature data stored in the log signature data storing means;
totaling the calculated hash values;
creating signature data of total log data by giving a digital signature to the totaled hash value by using the stored first private key; and
storing total signature data indicating the signature data of the created total log data.

10. The method according to claim 9, wherein the user signature data, signature object data and public-key certificate data are received together with a print job through a network.

11. The method according to claim 9, wherein data required to create the stored user signature data, signature object data and public-key certificate data are obtained from a connected external memory.

12. The method according to claim 9, further comprising encrypting the user signature data, signature object data, public-key certificate data, log data, log signature data and the total signature data by using a key stored in a computer of a manager connected through a network.
